(19) United States
(12) Patent Application Publication
(10) Pub. No.: US 2009/0106239 A1
(43) Pub. Date: Apr. 23, 2009

(54) Document Review System and Method

(76) Inventors: Christopher E. Getner, Arlington, VA (US); Robert D. Rowe, New York, NY (US)

Correspondence Address: BARNES & THORNBURG LLP, 600 ONE SUMMIT SQUARE, FORT WAYNE, IN, 46802, US

(21) Appl. No.: 12/253,508

(22) Filed: Oct. 17, 2008

Related U.S. Application Data
(60) Provisional application No. 60/981,132, filed on Oct. 19, 2007.

(51) Int. Cl. G06F 7/06; G06F 17/30

(52) U.S. Cl. 707/5; 707/E17.014

(57) ABSTRACT

A system and method for reviewing electronic documents. The method may include the step of using a computing device to rate a document's relevancy to a concept. Depending on the document's relevancy rating, the document could be routed to either substantive review personnel or relevancy review personnel. If the relevancy rating indicates that the document is likely relevant to the concept, the document is routed to substantive review personnel for substantive analysis. If the relevancy rating indicates that the document is likely irrelevant to the concept, the document is routed to relevancy review personnel to confirm whether the document is irrelevant to the concept. If the relevancy review personnel determine that the document is likely relevant to the concept, the document is rerouted to the substantive review personnel for substantive analysis.

### RELATED APPLICATION

This application claims priority to U.S. Provisional Application 60/981,132 filed Oct. 19, 2007, the entire disclosure of which is hereby incorporated by reference.

### TECHNICAL FIELD

The present invention relates generally to a system and method for reviewing electronic documents.

### BACKGROUND

Electronic discovery in litigation is now mandated by the Federal Rules of Civil Procedure. In many cases, the parties must review thousands (if not millions) of electronic documents to determine relevance, privilege, issue coding, etc. Typically this involves a substantial expense for the parties due to the time required to review these documents, which is typically charged by the hour for all documents, whether relevant or not. This issue arises in other contexts as well, such as compliance with corporate policies, Sarbanes-Oxley compliance, etc.

Therefore, there exists a need for a novel system and method for reviewing documents that is efficient and cost-effective.

### SUMMARY

According to one aspect, the invention provides a method for reviewing electronic documents. The method may include the step of using a computing device to rate a document's relevancy to a concept. Depending on the document's relevancy rating, the document could be routed to either substantive review personnel or relevancy review personnel. If the relevancy rating indicates that the document is likely relevant to the concept, the document is routed to substantive review personnel for substantive analysis. If the relevancy rating indicates that the document is likely irrelevant to the concept, the document is routed to relevancy review personnel to confirm whether the document is irrelevant to the concept. If the relevancy review personnel determine that the document is likely relevant to the concept, the document is rerouted to the substantive review personnel for substantive analysis. In some embodiments, the document is routed to one or more relevancy review personnel who are located outside the United States if the document's relevancy rating indicates that the document is likely irrelevant to the concept. Embodiments are contemplated in which the substantive review personnel analyze the document for at least one of: attorney/client privilege, work product doctrine protection, and responsiveness to discovery requests.

According to another aspect, the invention provides a document review system that may include a concept search module configured to rate a document's relevancy to a concept. A work flow module could also be included for routing the document to substantive review personnel if the document's relevancy rating exceeds a predetermined relevancy rating. The work flow module could route the document to relevancy review personnel if the document's relevancy rating falls below the predetermined relevancy rating. In some cases, the work flow module may be configured to reroute the document to the substantive review personnel if the relevancy review personnel determines that the document is likely relevant to the concept. Embodiments are contemplated in which the system includes an analysis module configured to evaluate the rate at which documents are rerouted by the work flow module.

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is a block diagram showing an example document review system; and

FIG. 2 is a flow chart showing example steps that may be performed during operation of the example document review system.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

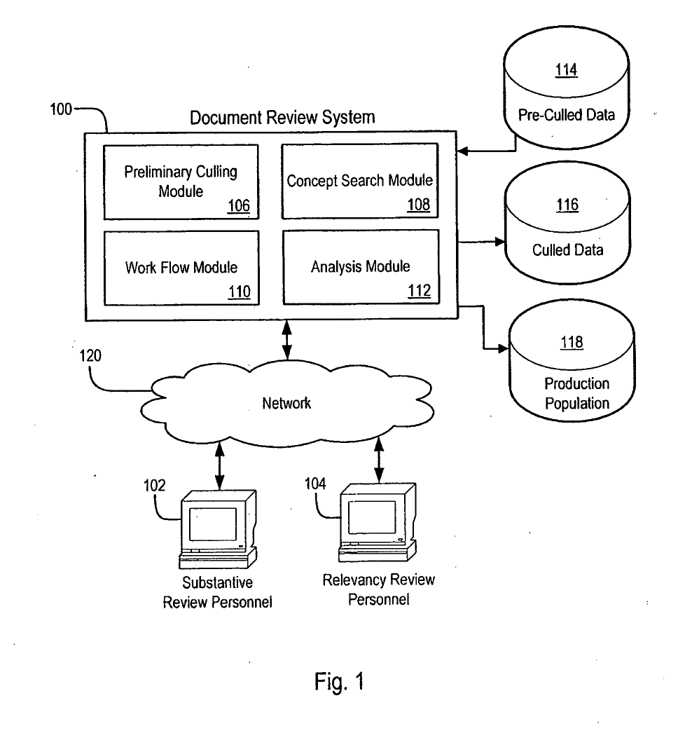

FIG. 1 shows an illustrative embodiment of a document review system 100 that may be used to analyze electronic documents. The terms “electronic document(s),” “document(s),” and “file(s)” are intended to encompass any type of electronic file, including but not limited to word processing documents, spreadsheets, presentations, images, videos, emails, metadata, system files, etc. The system 100 provides a manner for reviewing documents in an efficient, cost-effective manner. In some embodiments, a preliminary computer analysis segregates documents between a substantive review track and a relevancy review track based on likely relevance.

In the substantive review track, the documents that were deemed likely relevant by the computer analysis are made available to substantive review personnel 102 for analysis. In a litigation review setting, for example, the substantive review personnel 102 could analyze documents for privilege (e.g., attorney/client privilege or work product doctrine), analyze documents for responsiveness to discovery requests, code documents for legal issues (e.g., liability, damages, etc.), code “hot” documents (i.e., particularly significant documents), etc.

In the relevancy track, the documents that were deemed likely irrelevant by the computer analysis are made available to relevancy review personnel 104 to determine whether the documents are actually irrelevant to the issues at hand. If the relevancy review personnel 104 determine that a document is actually relevant, the document is “kicked back” (i.e., routed to) the substantive review track for substantive analysis.

The dual track review employed by the system 100 provides efficiencies because the relevancy review personnel 104 would not need to be as experienced as the substantive review personnel 102, thereby reducing cost. In this vein, embodiments are contemplated in which the relevancy review personnel 104 could be persons with a lower hourly rate than those of the substantive review personnel 102.

Although the system 100 will be primarily described herein with respect to electronic discovery in litigation, embodiments are contemplated in which the system 100 could be used in other environments including but not limited to the enforcement of corporate compliance policies. In the embodiment shown, the system 100 includes a preliminary culling module 106, a concept search module 108, a work flow module 110, and an analysis module 112. Although each of these subsystems 106, 108, 110, and 112 are shown in FIG. 1, it is contemplated that one or more of the subsystems could be optional depending on the circumstances.

The preliminary culling module 106 may be configured to preliminarily filter a collection of electronic documents based on desired criteria. In the example shown, a pre-culled data set 114 could initially contain the entire universe of documents collected for a document review. A culled data set 116 would initially be empty, but documents that are deemed irrelevant, for whatever reason, could be stored in the culled data set 116 instead of being deleted. For example, documents in the pre-culled data set 114 that are outside of the desired review criteria could be moved to the culled data set 116. In circumstances where irrelevant documents are intended to be deleted, the culled data set 116 is not needed. A production population data set 118 could be provided to store documents that are deemed relevant by substantive review personnel 102, possibly along with associated information, including but not limited to privilege coding, issue coding, etc. The pre-culled data set 114, culled data set 116, and production population data set 118 are logical data groupings which could reside in one or more databases (or other data structures).

In some embodiments, the preliminary culling module 106 may include a duplication subsystem that moves duplicate documents within the pre-culled data set 114 to the culled data set 116. By way of another example, the preliminary culling module 106 may include a system file removal subsystem that is configured to move system and non-user data files from the pre-culled data set 114 to the culled data set 116. In some embodiments, the preliminary culling module 106 may include a date culling subsystem that is configured to move files in the pre-culled data set 114 that are outside of a desired data range to the culled data set 116. For example, the date culling subsystem could remove files from the pre-culled data set 114 based on the date a file was created, last modified, sent, etc. Embodiments are contemplated in which the preliminary culling module 106 may include a keyword culling subsystem that is configured to move files from the pre-culled data set 114 to the culled data set 116 based on keyword searching. For example, all documents in the pre-culled data set 114 that included the word or phrase “XYZ” could be moved to the culled data set 114.

The concept search module 108 may be configured to analyze documents for relevancy to concepts (e.g., issues) that are deemed relevant to a particular case. Typically, the concept search module 108 includes a concept search engine that allows searching/clustering of documents by concept. This differs from a keyword search in that a concept search may understand the context of words in a document and other words that are often linked to the concept. For example, a search for the “damages” may elicit documents that include the words “profit,” “bottom line” “price,” etc. If a case involved five issues, for example, the concept search module 108 could be configured to determine which documents were likely relevant to one or more of these issues. For example, the concept search module 108 could weight or score documents based on particular concepts.

Consider an example in which the weight falls between 0 and 100 for each concept, with 0 indicating an extremely low likelihood of relevancy to a concept and 100 indicating an extremely high likelihood of relevancy to a concept. If a document scored Concept 1: 3, Concept 2: 6, Concept 3: 2, Concept 4: 1, and Concept 5: 7, the document may be routed to the relevancy review team 104 because the scores may fall below a likely relevant threshold set by the work flow module 110. If a document scored Concept 1: 90, Concept 2: 2, Concept 3: 7, Concept 4: 3, and Concept 5: 11, the document may be routed to the substantive review team 102 because the score for Concept 1 may exceed a likely relevant threshold set by the work flow module 110.

In some cases, the concept search module 108 could cluster documents based on particular concepts or types of documents. In some embodiments, the concept search module 108 could be configured to find more documents similar to an example document. For example, a reviewer could select a “More Like These” link to see documents with scores similar to the currently viewed document. If a “hot” document were found early in the review, for example, this may reveal other “hot” documents earlier in the review process. For example purposes only, the concept search module 108 may be the software sold under the name IDOL™ Server by Autonomy, Inc. of San Francisco, Calif.

The work flow module 110 may be configured to manage the flow of documents from the pre-culled data set 114 to either the substantive review personnel 102 or the relevancy review personnel 104 depending on the likely relevance of the document determined by the concept search module 108. The work flow module 110 routes documents that are likely to be relevant to the substantive review personnel 102 while documents that are likely to be irrelevant are routed to the relevancy review personnel 104. The documents analyzed by the substantive review personnel 102 are stored in the production population data set 118, along with possibly other information, such as associated privilege, issue coding, etc., of the documents. The documents confirmed by the relevancy review personnel 104 to be irrelevant are stored in the culled data set 116 (or deleted if desired). If the relevancy review personnel 104 determine that a document may be relevant, irrespective of the concept search module 108, the work flow module 110 routes the document to the substantive review personnel 102.

The analysis module 112 may be configured to analyze the efficiency of work flow, quality issues, and possibly other analysis. For example, the analysis module 112 could be configured to determine the rate at which documents are routed from the relevancy review personnel 104 to the substantive review personnel 102. This information could be used to tweak the concept search module 108. If the rate is higher than desired, for example, this could indicate that the concept search module 108 needs to be changed to add and/or modify the concept(s) that are being searched.

Although the example system 100 is represented by a single block in FIG. 1, the operation of the system 100 may be distributed among a plurality of computing devices. For example, it should be appreciated that various subsystems 106, 108, 110, 112 (or portions of subsystems) may operate on different computing devices. In some such embodiments, the various subsystems of the system 100 may communicate over a network 120. Likewise, the substantive review personnel 102 and relevancy review personnel 104 are shown as single computing devices in FIG. 1, but could be indicative of a plurality of reviewers. In some cases, the reviewers could be located in different geographical areas. For example, the substantive review personnel 102 could be located in the United States while the relevancy review personnel 104 could be located in India. By way of another example, the substantive review personnel 102 could be located in New York while the relevancy review personnel 104 could be located in Seattle. By way of a another example, the substantive review personnel 102 could be distributed among New York, London, Chicago, and Tokyo while the relevancy review personnel 104 could be distributed among Indianapolis, St. Louis, and India.

In some cases, the review personnel 102 and 104 use computing devices to communicate with the system 100 through a shared public infrastructure, such as the Internet. The network may be any type of communication scheme that allows computing devices to share and/or transfer data. For example, the network may include fiber optic, wired, and/or wireless communication capability and any of a plurality of protocols, such as TCP/IP, Ethernet, WAP, IEEE 802.11, or any other protocol. The data exchanged over the network may be represented using technologies and/or formats including but not limited to the hypertext markup language (“HTML”), the extensible markup language (“XML”), and the simple object access protocol (“SOAP”), etc. The computing devices used by the reviewers 102 and 104 may include, but are not limited to, desktop computers, tablet computers, notebook computers, and/or personal digital assistants (“PDAs”). Alternatively, information regarding documents reviewed by the relevancy and substantive review personnel 102 and 104 could be batched to the system 100 on a periodic basis.

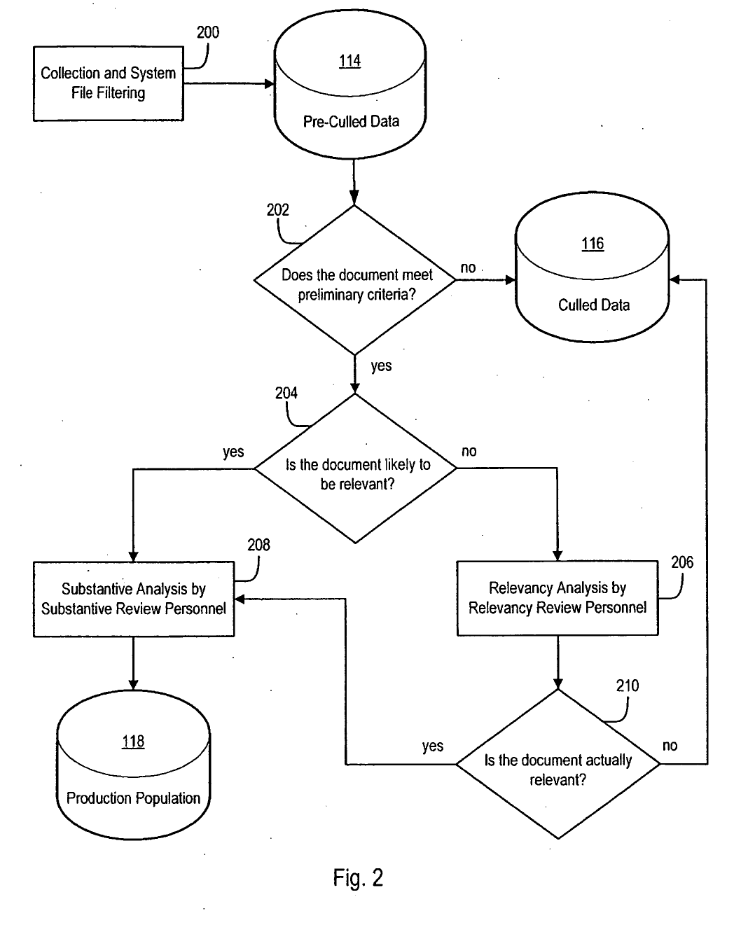

FIG. 2 shows example steps that may occur during the operation of the system 100. A universe of documents for the review are collected in the pre-culled data set 114 (Block 200). By way of example, the documents could be collected using standard forensic tools. In some cases, “system” and non-user-data files are culled out (i.e., transferred to the culled data set). For example, a comparison of the files by type and by MD5 (Message-Digest algorithm 5) sum comparison to known operating system files could be performed.

Depending on the particular review parameters, documents could be reviewed to determine whether they meet certain preliminary parameters (Block 202). If not, the document may be transferred to the culled data set. For example, certain duplicate files could be removed, documents could be culled based on keywords, and/or date restrictions. By way of example, scripts could be used to remove duplicate files on either a custodian basis or across the whole document collection. For example, the scripts could review the MD5 sum values of the files or a similar value of the metadata of emails.

The documents may then be analyzed to determine the likely relevance (Block 204). For example, the documents could be analyzed using Autonomy, Inc.'s concept search and clustering technology. In some cases, this may include a review by trained data specialists to examine the concepts in the corpus of documents. Based on the particulars of the document review and possibly after in-depth discussions with the parties/attorneys involved in the review, clusters of documents around specific concepts will be identified. The documents that are clustered around concepts that are likely to be not relevant to the matter at hand are assigned to the relevancy review personnel for further review of relevance (Block 206). The documents that are clustered around concepts that are likely to be relevant to the matter at hand are assigned to substantive review personnel (Block 208) for immediate substantive evaluation, such as analysis of responsiveness, privilege, and matter-specific issue codes.

Prior to beginning the review, the relevancy review personnel 104 are trained so that potentially relevant documents can be detected. In some cases, for example, the individual reviewers attend training and are required to complete a sample set of documents with a predetermined success level (at detecting potentially relevant documents) prior to being assigned to a project. If a reviewer fails the test set, additional training and retesting is required until a successful test result is achieved. The relevancy review personnel 104 evaluate each document for its potential relevance to the matter at hand. If a document is confirmed to be not relevant it will be marked as such and transferred to the culled data set 116. If a document is determined to be likely relevant to the matter at hand, it will be marked as such. Any documents that are tagged as likely relevant, are “kicked back” to the substantive review personnel 102 for substantive review (e.g., privilege, responsiveness, any issue codes, etc.), as indicated by Block 210.

Prior to beginning the review, the substantive review personnel 102 are trained on the particulars of the matter at hand so that documents can be coded appropriately. In some cases, for example, the individual reviewers attend training and are required to complete a sample set of documents with a predetermined success level (at coding various issues, etc.) prior to being assigned to a project. If a reviewer fails the test set, additional training and retesting is required until a successful test result is achieved. In a litigation review context, the documents that pass through the substantive review personnel 102 and are deemed responsive are produced for either opposing counsel or the other party depending upon the parameters of the review. The production can be in image format (e.g., TIFF) for conventional review or in native form and delivered to various formats for further review.

In some embodiments, the substantive review personnel 102 and/or relevancy review personal 104 may be grouped into one or more “pods.” By way of example only, each pod could include approximately 10-20 reviewers. Typically, each pod has a lead reviewer that is responsible for managing the reviewers and assigning documents to be reviewed. Each pod also has a dedicated quality control reviewer. Each pod could be assigned documents of a similar concept grouping by the lead reviewer. The concept grouping is an additional level of clustering beyond the relevance designation, and focuses on grouping similar types of documents together. Every day a statistical sample of each reviewer's work may be swept into a collection for reevaluation by the quality control reviewer in each pod. The quality control reviewer will verify correct coding of documents and will correct documents coded improperly. In addition, the quality control reviewer will record the type of mistake made. Feedback is gathered for individual reviewers, as well as review pods, and delivered to the lead reviewer for further training to correct the errors on either an individual or group basis.

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A method for efficiently analyzing electronic data using a processor, the method comprising the steps of:
rating the relevancy of an electronic data collection based on a set of criteria using a processor;
arranging the electronic data collection into a first data set that is rated likely relevant and a second data set that is rated likely irrelevant using the processor;
routing the first data set to one or more substantive review personnel, wherein the substantive review personnel have been trained to substantively review data in the first data set;
routing the second data set to one or more relevancy review personnel, wherein the relevancy review personnel have been trained to verify whether data in the second data set is likely irrelevant to the set of criteria; and
routing a data element in the second data set from the relevancy review personnel to the substantive review personnel in the event that the relevancy review personnel determines that the data element is not likely irrelevant to the set of criteria.

2. The method of claim 1, wherein the rating step rates the relevancy of the electronic data collection based on a conceptual search.

3. The method of claim 2, wherein the processor clusters conceptually-related data elements in the electronic data collection based on the conception search.

4. The method of claim 3, wherein the substantive review personnel are arranged into groups and wherein the first data set is conceptually clustered and routed so that conceptually-related data elements are primarily reviewed by the same group.

5. The method of claim 2, wherein the processor rates a plurality of data elements in the electronic data collection as to a plurality of concepts.

6. The method of claim 5, wherein the processor is configured to retrieve one or more data elements in the electronic data collection that have a substantially similar rating as a selected data element.

7. The method of claim 1, further comprising the step of monitoring an amount of data elements that are routed from the relevancy review personnel to the substantive review personnel.

8. The method of claim 7, further comprising the step of providing an alert if the amount of data elements that is routed from the relevancy review personnel to the substantive review personnel exceeds a threshold amount.

9. The method of claim 7, wherein the threshold amount is a percentage of data elements routed from the relevancy review personnel to the substantive review personnel as to a total amount of data elements in the second data set reviewed by the relevancy review personnel.

10. The method of claim 7, further comprising the step of adjusting the set of criteria if the amount of data elements routed from the relevancy review personnel to the substantive review personnel exceeds a threshold amount.

11. The method of claim 1, wherein at least one data element in the second data set is routed to relevancy review personnel who are located outside the United States.

12. A data processing system comprising:
means for rating the relevancy of an electronic data collection based on a set of criteria;
means for arranging the electronic data collection into a first data set that is rated likely relevant and a second data set that is rated likely irrelevant;
means for routing the first data set to one or more substantive review personnel, wherein the substantive review personnel have been trained to substantively review data in the first data set; and
means for routing the second data set to one or more relevancy review personnel, wherein the relevancy review personnel have been trained to verify whether data in the second data set is likely irrelevant to the set of criteria;
means for routing a data element in the second data set from the relevancy review personnel to the substantive review personnel in the event that the relevancy review personnel determines that the data element is not likely irrelevant to the set of criteria.

13. A method for efficiently analyzing electronic data using a processor, the method comprising the steps of:
rating relevancy of data elements in an electronic data collection based on one or more issues relevant to an adversarial proceeding;
assigning review of data elements rated as likely relevant to at least one of the issues to one or more substantive review personnel for substantive analysis;
tagging data elements responsive to input received from substantive review personnel as to at least one of: attorney/client privilege, work product protection, or responsiveness to discovery requests;
assigning review of data elements rated as likely irrelevant to relevancy review personnel for confirmation concerning irrelevancy; and
reassigning review of a data element from the relevancy review personnel to the substantive review personnel responsive to input received from the relevancy review personnel indicating that the data element is not irrelevant.

14. The method of claim 13, wherein the rating step is performed, at least in part, by a concept search engine.

15. The method of claim 13, further comprising the step of training the relevancy review personnel bow to determine whether a data element is irrelevant, wherein the training step includes a requirement that relevancy review personnel accurately determine relevancy of a sample data set.

16. The method of claim 15, further comprising the step of training the substantive review personnel how to code a data element for substantive issues concerning the adversarial proceeding, including a requirement that substantive review personnel accurately determine substantive issues, including attorney/client privilege and work product protection, for a sample data set.

17. The method of claim 16, wherein the relevancy review personnel are not trained to detect attorney/client privilege and work product protection of data elements.

18. The method of claim 13, further comprising the step of establishing one or more qualification requirements for the substantive review personnel and the relevancy review personnel, wherein the qualification requirements for substantive review personnel has a higher educational requirement than the relevancy review personnel.

19. The method of claim 18, wherein the qualification requirements for substantive review personnel include a valid license to practice law in a U.S. state, wherein the relevancy review personnel are not required to have a valid license to practice law in a U.S. state.

20. A document review system comprising:
a concept search module configured to rate a document's relevancy to a concept;
a work flow module configured to route the document to substantive review personnel if the document's relevancy rating exceeds a predetermined relevancy rating and route the document to relevancy review personnel if the document's relevancy rating falls below the predetermined relevancy rating; and
wherein the work flow module is configured to reroute the document to the substantive review personnel if the relevancy review personnel determines that the document is likely relevant to the concept.

21. The document review system of claim 20, further comprising an analysis module configured to evaluate a rate at which documents are rerouted by the work flow module.
